(19) United States
(12) Patent Application Publication
(10) Pub. No.: US 2004/0261831 A1
(43) Pub. Date: Dec. 30, 2004

(54) On-board generation system

(75) Inventors: Osamu Tsuneoka, Tokyo (JP); Naruhito Kondo, Kawasaki-Shi (JP); Akihiro Hara, Yokohama-Shi (JP); Naoki Shutoh, Yokohama-Shi (JP); Shinya Sakurada, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/826,273

(22) Filed: Apr. 19, 2004

(30) Foreign Application Priority Data
Apr. 18, 2003 (JP) 2003-114902

(51) Int. Cl. G10H 5/00

(52) U.S. Cl. 136/205

(57) ABSTRACT

An on-board generation system of a vehicle includes an on-board combustor mounted to a vehicle independently from an engine thereof, a high-temperature system line for circulating a thermal medium for receiving heat caused through a combustion process in the combustor, a low-temperature system line for circulating a medium on a low-temperature side which is subjected to heat exchanging with the thermal medium, and an electric generator, arranged between the high-temperature system line and the low-temperature system line, for recovering the thermal energy of the thermal medium as electric energy, in which the electric power generated by the electric generator is supplied to a power source including either one of an on-board battery and a power supply element for driving a vehicle equipment.

### BACKGROUND OF THE INVENTION

1. Field of the Invention

The present invention relates to a compact and light-weight on-board type power generation system having a combustor and, in particular, to an on-board power generation system having a combustor for recovering or recycling, as electric energy, thermal energy generated in the on-board combustor so as to reduce load on a power source such as an on-board battery. This on-board generation system having a combustor may be called hereunder “on-board combusting generation system”.

2. Related Art

As human beings are consuming energy more and more, global warming resulting from greenhouse gas such as CO₂ becomes serious. In order to reduce the generation of such CO₂ as much as possible, it has been severely required to realize a generation system that makes it possible to recycle waste energy, which is now disposed, as electric energy as much as possible.

In a car industry, in order to control the generated amount of CO₂, every effort has been done to increase car mileage with improved engine performance and with a lightweight design of a vehicle body. Along with an increased mileage in the performance improvement, an idling stop regulation has been widely known around the world while an idling stop campaign has been globally promoted. The idling stop practice draws attention because it is an easiest remedial step to implement without the need for any additional costs involved, and hence, is substantially effective in reducing the amount of CO₂ emission.

If the idling operation of a vehicle stops, since the engine revolution at the operation start time increases, a total power required to start the engine during the operation will be increased. However, since an on-board generator such as an alternator is not used as a power source for starting the engine, the power supply must be dependent only on a battery. Because of this reason, the increasing of the effectiveness of the idling stop practice will require the increasing of the capacity of the battery. The increase in the capacity of the battery results in an increase in the weight of the vehicle, leading to a drop in the mileage, thus being inconvenient.

Furthermore, to realize the idling stop without increasing the battery capacity, the battery must be overused, which results in the shortening of the service life of the battery and the increasing of the maintenance cost, thus being not practical.

In addition, in a case of an insufficient capacity, the battery supplies insufficient power, thereby aborting an engine start.

On the other hand, if the idling remains stopped, warm air cannot be supplied inside the vehicle, and in countries located in high-latitude areas, having a long winter season, a burning heater of a vehicle (i.e., on-board heater) is commercially available to supply warm air in the vehicle with the engine stopping. In such area, the on-board burning heater warms air inside the vehicle with the engine stopping by burning fossil fuels such as light oil or gasoline.

Since the vehicle burning heater consumes fuel less than the engine that supplies warm air during the idling state, a reduction in CO₂ emission can be achieved. However, an on-board battery has been used as a power source for driving and controlling an air circular fan and a hot-water pump, and in its typical capacity, the battery is unable to provide heating of long time, thus being not available.

Moreover, the vehicle burning heater, discharging combustion exhaust gas outwardly without being processed, is not environmentally friendly.

### SUMMARY OF THE INVENTION

It is an object of the present invention, in consideration of the circumstances encountered in the prior art mentioned above, to provide an on-board generation system capable of being environmentally friendly and economical and recovering waste heat from an on-board combustor in the form of electric energy, while feeding power even during an engine stop.

It is another object of the present invention to provide an on-board generation system capable of providing a comfortable condition to passengers of the vehicle during an idling stop period and obviating the idling run for heating.

It is a further object of the present invention to provide an on-board generation system capable of reducing the load on a power source such as on-board battery, stopping the idling operation without reducing the battery capacity and service life, permitting a continuous use of a vehicle heater during an idling stop period and overcoming an inconvenience of insufficient power.

It is a still further object of the present invention to provide an on-board generation system capable of providing the power source for the vehicle heater during the idling stop period and cleaning an exhaust gas by using power of the generator in an environmentally friendly manner.

It is a still further object of the present invention to provide an environmentally friendly on-board generation system capable of setting a vehicle (on-board) combustor in a burning method independently from an engine to reduce exhaust gas, as well as substantially reducing fuel consumption.

The above and other objects can be achieved according to the present invention by providing, in one aspect, an on-board generation system comprising: an on-board combustor mounted to a vehicle independently from an engine thereof; and an electric generator, mounted to the on-board combustor, for recovering a thermal energy obtained through combustion process as an electric energy by using a thermoelectric converter, wherein the electric power generated by the electric generator is supplied even at a time of engine operation stop.

The above and other objects can be also achieved according to the present invention by providing, in another aspect, an on-board generation system comprising: an on-board combustor mounted to a vehicle independently from an engine thereof; a high-temperature system line for circulating a thermal medium for receiving heat caused through a combustion process in the combustor; a low-temperature system line for circulating a medium on a low-temperature side which is subjected to heat exchanging with the thermal medium; and an electric generator, arranged between the high-temperature system line and the low-temperature system line, for recovering the thermal energy of the thermal medium as electric energy, wherein the electric power generated by the electric generator is supplied to a power source including either one of an on-board battery and a power supply element for driving a vehicle equipment.

In preferred embodiments of the above aspects, the thermal medium on the high-temperature system line may be either one of a combustion gas in a combustion chamber of the on-board combustor and an exhaust gas discharged from the combustion chamber, and the low-temperature side medium is either one of an air outside a vehicle and an air inside the vehicle.

The thermal medium on the high-temperature system line may otherwise be either one of a combustion gas in a combustion chamber of the on-board combustor and an exhaust gas discharged from the combustion chamber, and the low-temperature side medium is a water circulated from either one of a radiator and an on-board heating system.

The thermal medium on the high-temperature system line may be an exhaust gas subsequent to the combustion process in a combustion chamber of the combustor, and the low-temperature side medium is a water circulated from either one of a radiator and an on-board heating system.

The on-board generation system may further comprises an exhaust gas cleanup device arranged in an exhaust gas line extending from the on-board combustor, the exhaust gas cleanup device comprising a discharge reactor for generating chemically active species by carrying out a discharging process to the exhaust gas and a catalyst reactor having a catalyst activated by the chemically active species generated in the discharge reactor. The electric generator supplies power to either one of the exhaust gas cleanup device and the power source including at least the on-board battery and the power supply element for driving a vehicle equipment.

The electric generator may comprise one of a thermoelectric converter, a thermionic energy converter, and a combination thereof. One of the thermoelectric converter, the thermionic energy converter and the combination thereof constitutes a generation module. The combustor has a cylindrical combustor casing defining the combustion chamber, and at least one of the generation modules is mounted to an outer or inner peripheral surface of the combustor casing.

The electric generator may comprise either one of a voltage step-up unit and a voltage step-down unit for adjusting the generated power to a load during use.

The electric generator may further comprise a voltage detecting circuit for automatically detecting and discriminating the generation of voltage, the voltage detecting circuit controlling a power supplying by making or breaking an electric line supplying power from the electric generator to a load.

According to the characters and structures of the present invention and its preferred embodiments, the on-board generation system of the present invention is environmentally friendly and economical, and recovers waste heat from the on-board combustor in the form of electric energy, while feeding power even during an engine stop. The on-board generation system provides the comfortability during an idling stop period and obviates the idling run for heating.

Furthermore, the on-board generation system can reduce the load on the vehicle battery, can stop the idling operation without reducing the battery capacity and service life, can permit a continuous use of a vehicle heater during the idling stop period, and can overcome the problem of insufficient power. There may be also provide a power source for the vehicle heater during the idling stop period, and the exhaust gas can be made clean by using the power generated from the generator in an environmentally friendly manner.

Furthermore, the environmentally friendly on-board generation system sets the vehicle combustor in a burning method separate from an engine to reduce exhaust gas, substantially reduces fuel consumption, i.e., fuel cost, lowers operating noise level and provides the comfortable heating.

The natures and further characteristic features of the present invention will be made more clear from the following descriptions made with reference to the accompanying drawings.

### BRIEF DESCRIPTION OF THE DRAWINGS

In the accompanying drawings;

FIG. 1 is a block diagram illustrating the principle of an on-board generation system provided with a combustor (which may be called merely (on-board) generation system or on-board combusting generation system, hereinlater) in accordance with a first embodiment of the present invention;

FIG. 2 illustrates an internal structure of the generation system in accordance with the first embodiment of the present invention;

FIG. 3 is a view showing a layout of generation modules housed in a generator in the on-board generation system of the first embodiment of the present invention;

FIGS. 4A and 4B illustrate the structure of the generation modules;

FIG. 5 illustrates an exhaust gas cleanup device in the on-board generation system in accordance with the first embodiment of the present invention;

FIG. 6 illustrates an exhaust gas cleanup process of the on-board generation system of the first embodiment of the present invention;

FIG. 7 illustrates an internal structure of an on-board generation system in accordance with a second embodiment of the present invention;

FIG. 8 is a block diagram illustrating the principle of an on-board generation system in accordance with a third embodiment of the present invention;

FIG. 9 is a block diagram illustrating the principle of an on-board generation system in accordance with a fourth embodiment of the present invention;

FIG. 10 illustrates the internal structure of the on-board generation system in accordance with the fourth embodiment of the present invention;

FIG. 11 is a block diagram illustrating the principle of an on-board generation system in accordance with a fifth embodiment of the present invention;

FIG. 12 illustrates a first modification of the generator in the on-board generation system of the preferred embodiments of the present invention mentioned above; and

FIG. 13 illustrates a second modification of the generator in the on-board generation system of the preferred embodiments of the present invention mentioned above.

### DESCRIPTION OF THE PREFERRED EMBODIMENTS

An on-board generation system of preferred embodiments of the present invention will be discussed hereunder with reference to the accompanying drawings.

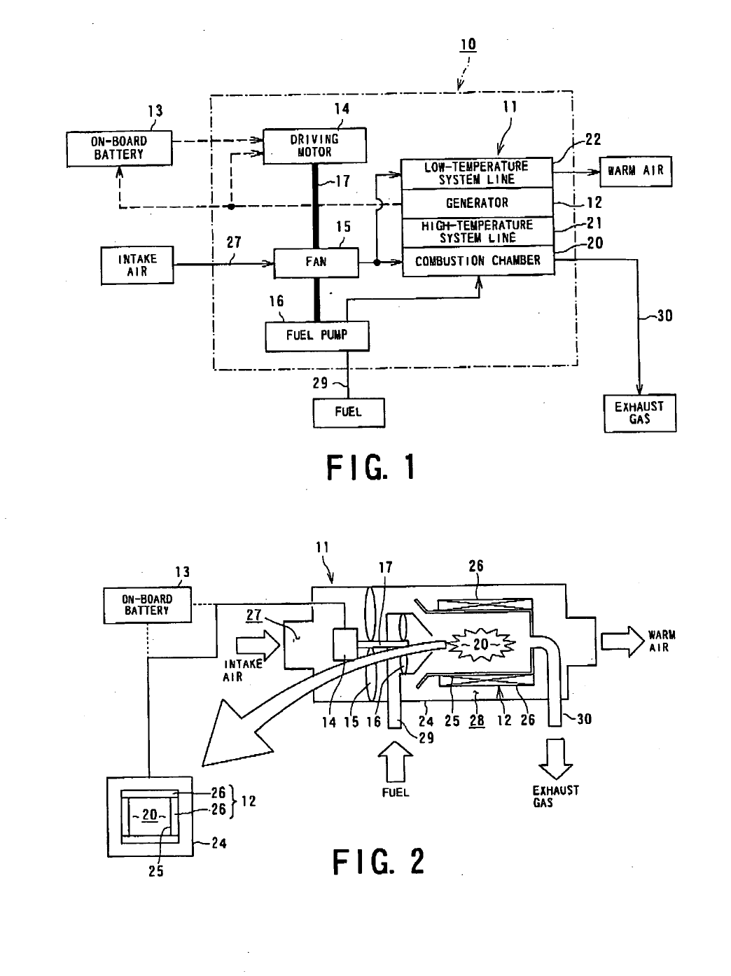

FIG. 1 is a block diagram illustrating the principle of an on-board generation system 10 provided with a combustor in accordance with the first embodiment of the present invention, and FIG. 2 diagrammatically illustrates the internal structure of the generation system 10 of FIG. 1.

With reference to FIGS. 1 and 2, the on-board combusting generation system 10 is mounted in a compartment (including an engine unit) independently from an engine in each of heavy vehicles, commercial vehicles and passenger motorcars. The on-board combusting generation system 10 includes a generator provided with a heater (which may be called hereinlater a heating generator) 12 having a compact and lightweight on-board combustor 11 integrated therewith and generates and supplies required power even at a time of the engine stop operation.

The on-board combusting generation system 10 includes a driving motor 14, which is operated from an automobile battery 13, or the like. A fan 15 and a fuel pump 16 are driven by the driving motor 14, and the fan 15 and the fuel pump 16 are arranged on a motor output shaft 17 of the driving motor 14 so as to share a common drive shaft. Alternatively, the fan 15 and the fuel pump 16 may be separately driven by respective motors.

The on-board combustor 11 in the on-board combusting generation system 10 includes a combustion chamber 20 for mixing and burning an intake air and a fuel, a high-temperature system line 21 for recovering heat from a combustion gas, as a thermal medium, which has received heat through a combustion process in the combustion chamber 20, a low-temperature system line 22 for transferring the received heat to intake air or water, as a medium, and a generator 12, arranged between the high-temperature system line 21 and the low-temperature system line 22, for converting the thermal energy obtained in the combustion process into electric energy.

The on-board combustor 11, shown in FIG. 2, includes a cylindrical body casing 24. A combustor casing 25, generally coaxially arranged in the body casing 24, forms a burning heater. A combustion chamber 20 is arranged within the combustor casing 25. A plurality of generation modules 26 is arranged around the external circumference wall of the combustor casing 25. The generation modules 26, distributed generally around the external circumference wall (outer peripheral wall surface) of the combustor casing 25, constitute the generator 12.

The driving motor 14 is powered from the automobile battery (i.e., on-board battery) 13 or the like, and the fan 15 and the fuel pump 16 are driven by the driving motor 14. Air outside or inside a vehicle is taken into the cylindrical body casing 24 by rotating the fan 15 through an air supply passage 27, and is then supplied to a heat transfer passage 28 surrounding the combustion chamber 20 and the combustor casing 25. The heat transfer passage 28 has a cylindrical shape defined between the body casing 24 and the combustor casing 25. Upon receiving the heat emitted from the combustor casing 25, the heat transfer passage 28 heats the air taken therein, which is then heated and circulated into the vehicle compartment as warm air which is a low-temperature medium for the low-temperature system line 22.

Then, by rotating the fuel pump 16, the combustion chamber 20 in the on-board combustor 11 is supplied with oil such as light oil or gasoline through a fuel supply passage 29 from a fuel tank, not shown. The fuel is then mixed with the intake air and burned in the combustion chamber 20. A combustion gas generated through the combustion process is discharged outward as an exhaust gas through a gas discharging passage 30. The heat generated in the combustion process in the combustion chamber 20 is then recovered by a combustion gas, namely, a thermal medium constituting a high-temperature system line 21 and circulated towards the generator 12.

The heat transmitted to the generator 12 is converted into the electric power by the generation modules 26. The resulting electric power is stored in the vehicle (on-board) battery 13, while the battery 13 feeds power to the driving motor 14 and start-up power for the on-board combusting generation system 10. During such operation, the driving motor 14 may be powered by the power generated by the generator 12 rather than by the on-board battery 13. The power generated by the generator 12 may be fed to an exhaust gas cleanup system or an equipment for driving the power source in addition to the battery 13 or the like.

The heat transferred to the generator 12 (i.e., waste heat of the combustion gas) is converted into electric power by the generator 12. The intake air passing through the heat transfer passage 28, subject to the extra heat, rises in temperature, thereby becoming warmer. The air is thus discharged through the low-temperature system line 22 as warm air. Further, since this warm air is clean, it may be used for heating the vehicle compartment or may be mixed with the exhaust gas to be discharged through the gas discharging passage 30.

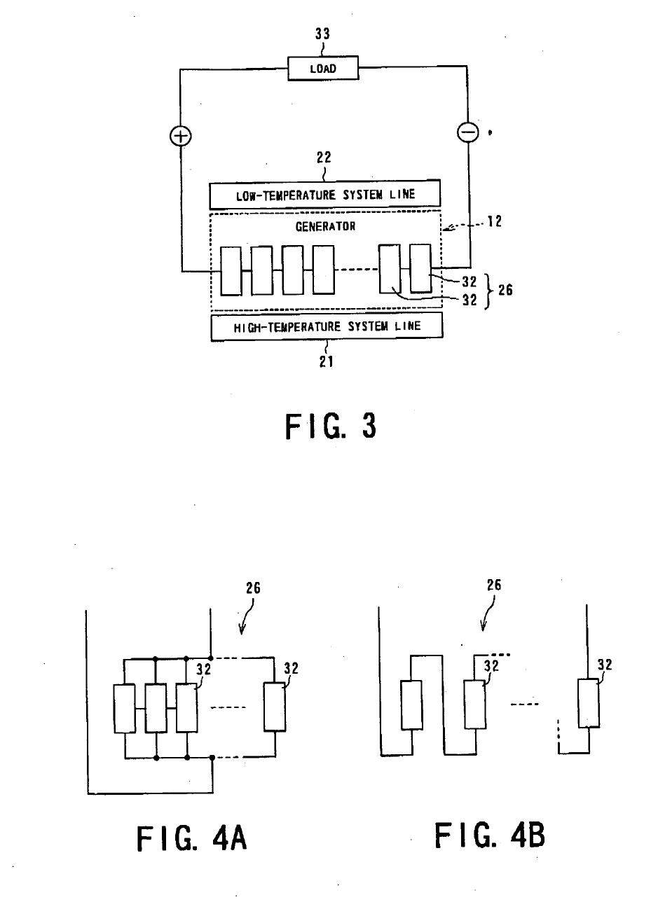

The generator 12 includes at least one generation module 26 for recovering electric energy from heat of the combustion gas. Each generation module 26 includes a plurality of thermoelectric converters 32, a plurality of thermionic energy converters, or a combination or assembly thereof. FIG. 3 illustrates the generation modules 26 connected in series. The thermoelectric converters 32 or the thermionic energy converters, constituting the generation module 26, are arranged so that a temperature difference between a high temperature side and a low temperature side is generally uniformly applied across both ends of the converters.

The thermoelectric converter 32 is a thermoelectric semiconductor containing, as major components thereof: germanium-silicon, bismuth-tellurium, bismuth-tellurium-selenium, bismuth-antimony, iron-antimony, iron-silicon, lead-tellurium, or boron-carbon; skutterudite or a thermoelectric semiconductor having a filled skutterudite-type crystal structure; or half-Heusler type compound.

To construct the generation modules 26, a number of thermoelectric converters 32 or thermionic energy converters may be connected in parallel as shown in FIG. 4A, or in series as shown in FIG. 4B. A plurality of thermoelectric converters 32 or thermionic energy converters may be connected in parallel in a group, and the groups may be connected in series to form the generation module 26. Each generation module 26, such as a series connection of 32 pairs of thermoelectric converters (64 thermoelectric converters), weighs several grams to over ten grams (10 to 20 g), thus providing the compact and lightweight generation module 26, which provides a DC power of several volts and several amperes, for example, 1.5 V and 2 A. A plurality of generation modules 26, if properly connected, outputs an electric power of over ten volts (10 to 20 g) and a several amperes. The generated power is then fed to a load 33 such as the vehicle battery 13 and the driving motor 14.

Because of its compact and lightweight design, the on-board combustor 11 may be installed, separately from an engine, not shown, in any available space in a vehicle compartment including an engine compartment space. The on-board combustor 11, also functioning as a compact and lightweight heater, consumes a fuel equal to several percent to 20 percent of the fuel used for the idling operation, for example, 10 percent of the idling operation. According to such low fuel consumption, there can be provided the on-board combustor 11 which is environmentally friendly.

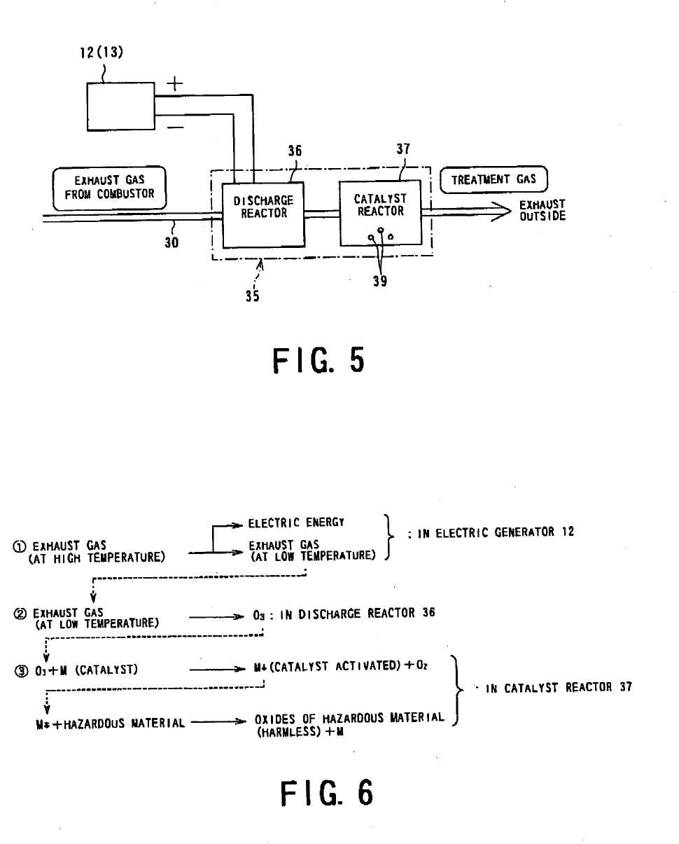

The on-board combusting generation system 10 further includes an exhaust gas cleanup system 35 in further consideration of the environmental safety. This exhaust gas cleanup system 35 is provided for a gas discharging passage 30 as shown in FIG. 5.

The exhaust gas cleanup system 35 includes a discharge reactor (discharge reaction section) 36 arranged along the gas discharging passage 30 and a catalyst reactor (catalyst reaction section) 37 arranged on the downstream side of the discharge reactor 36. The discharge reactor 36 is powered by the generator 12 or the on-board battery 13 through a power supply 38. The discharge reactor 36 is supplied with a high voltage to cause a corona discharge or an arc discharge, and preferably, the discharge reactor 36 causes a corona discharge using a dielectric substance.

A catalyst 39 is applied to the catalyst reactor 37 arranged downstream of the discharge reactor 36. Exhaust gases generated in the combustion process in the on-board combustor 11 includes hazardous materials such as NOx, dioxin compounds, CO, HC and foul odor materials. The discharge reactor 36 includes discharge electrodes, not shown, across which a pulse voltage or AC voltage is applied. Accordingly, only electrons of the exhaust gases containing hazardous materials are efficiently accelerated through the discharging of the discharge electrodes, and the charged particles are thereby intermittently produced, thus generating a plasma.

Electric energy of the plasma generated by the discharge reactor 36 efficiently generates chemically active species such as ozone and. OH radicals (OH⁻). The catalyst reactor 37 is provided with the catalyst 39, which is activated by the chemically active species. The catalyst 39 includes, at least, a catalytic agent (catalyst) for decomposing the ozone and a catalytic agent (catalyst) used for reducing NOx. More specifically, the catalyst 39 contains alumina-based NOx reducing catalysts using HC as a reducer, activated carbon, zeolite, ozone decomposing catalyst, or the like.

The exhaust gas cleanup system 35 performs the discharge and cleanup operation in the following manner.

The exhaust gas generated through the combustion process in the combustion chamber 20 of the on-board combustor 11 transfers the thermal energy thereof to the generation modules 26 for the power generation during the passing through the generator 12. The combustion gas with the dropped thermal energy thereof becomes an exhaust gas, which is guided to the gas discharging passage 30 and then discharged outward through the gas discharging passage 30.

When the exhaust gas passes through the gas discharging passage 30, the plasma generated in the discharge reactor 36 causes the chemically active species such as ozone and OH radicals (OH⁻). In the discharge reactor 36, the chemically active species oxidizes NO to NO₂ while oxidizing dioxin compounds at the same time. The foul odor materials of the exhaust gas are changed into odorless materials such as CO₂.

Further, the ozone (O₃) having long life, among the chemically active species, is moved together with the exhaust gas to the catalyst reactor 37. The catalysts, activated by the chemically active species in the catalyst reactor 37, perform catalytic treatment process on the hazardous materials without depending on the thermal energy of the exhaust gas, in addition to the discharge reaction process.

FIG. 6 illustrates the flow of the cleanup process of the exhaust gas performed by the exhaust gas cleanup system 35. In this process, the foul odor materials are processed by the catalytic activity of ozone.

Since the catalysts are activated in the exhaust gas cleanup system 35 by the chemically active species generated in the discharge reactor 36 rather than by the temperature of the exhaust gas, the thermal energy of the exhaust gas is efficiently recovered as electric energy while reducing the emission amount of the hazardous exhaust components.

The generation process of the on-board combusting generation system 10 and the decomposition of the foul odor components in the exhaust gas will be discussed hereunder with reference to the results of tests (experiment).

A mixture of hydrogen sulfide (H₂S) and air, in which content of H₂S is 20 ppm, was heated as a model odor gas to a temperature of 400° C. and guided to the generator 12. In the generator 12, the generation module 26, including P type or N type thermoelectric converters 32 containing, as major components thereof, skutterudite, half-Heusler type compound, germanium-silicon, lead-tellurium, or bismuth-tellurium-antimony, was glued to or attached to the combustor casing 25 or the gas discharging passage 30. The generation modules 26 thus generated power based on a temperature difference between the exhaust gas temperature and the ambient air temperature.

The exhaust gas lost its thermal energy to a temperature of 150° C. through an electricity generation process and was then guided to the discharge reactor 36 at the low temperature state thereof. The foul odor components of 95% in the exhaust gas was decomposed by the ozone decomposing catalyst 39 in the catalyst reactor 37 caused in the discharging process. In comparison, when the foul odor components of the exhaust gas were cleaned at 150° C. by using only the catalyst, the decomposition rate of the foul odor components was 42%.

As is apparent from the above experiment (test result), by mounting the exhaust gas cleanup system 35 to the on-board combusting generation system 10, the thermal energy is sufficiently recovered as electric energy from the exhaust gas. As expected from a reaction process illustrated in FIG. 6, it was found that the catalyst activation process of the ozone generated through the discharge process permits the foul odor components to be decomposed even at a temperature as low as 150° C., which is typically too low temperature for the catalyst to sufficiently attain its function.

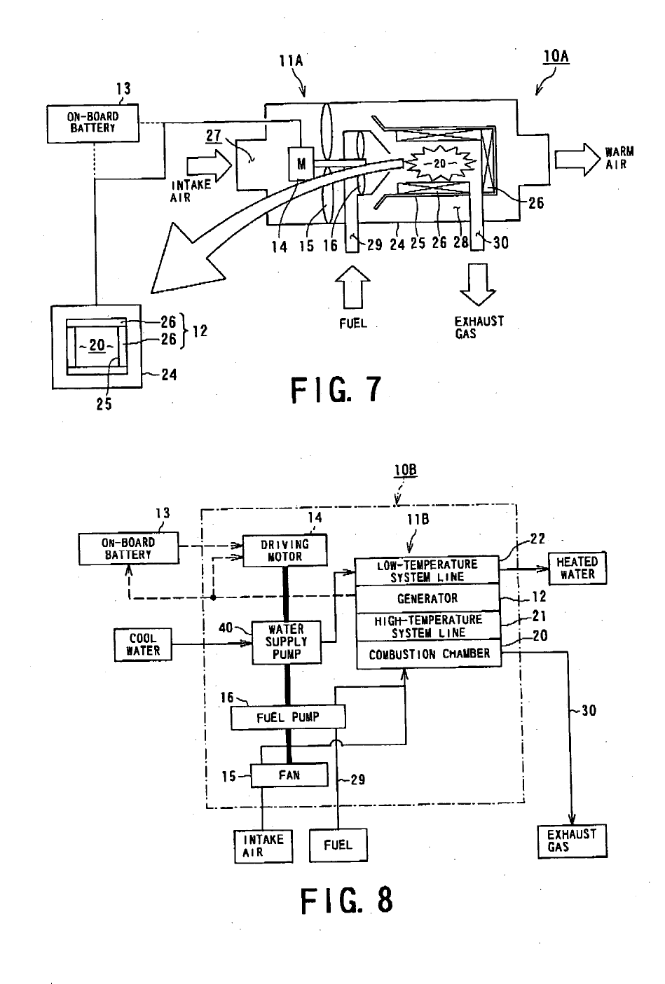

FIG. 7 illustrates the internal structure of an on-board combusting generation system 10A in accordance with the second preferred embodiment of the present invention.

With reference to FIG. 7, the on-board combusting generation system 10A of the second embodiment includes an on-board combustor 11A instead of the on-board combustor 11 of the first embodiment represented by FIG. 2. The other structures of the on-board combusting generation system 10A are substantially the same as or identical to those of the on-board combusting generation system 10, and the corresponding portions or elements are designated with like reference numerals. The explanations thereof are therefore omitted herein.

In the on-board combustor 11A illustrated in FIG. 7, the generator 12 is arranged on the internal circumference, i.e., inner peripheral wall surface, of the combustion chamber 20. More specifically, the generation modules 26 forming the generator 12 are generally arranged on the inner peripheral wall surface of the combustor casing 25 defining the combustion chamber of the on-board combustor.

As mentioned above, since the structures, except that the generation modules 26 are arranged on the inner peripheral wall surface of the combustor casing 25, are substantially the same as those of the first embodiment, only the difference between these two combustors 11 and 11A will be discussed hereunder.

In the on-board combustor 11A, the thermal energy of the combustion gas caused through the combustion process in the combustion chamber 20 acts on one end of each of the generation modules 26 to thereby cause a temperature difference between this one end and the other end of the generation module 26. The thermal energy of each generation module 26 is converted into the electric energy, in response to the temperature difference, which is then taken out as an electric power.

The electric power of the electric energy converted and generated by the generator 12 not only charges the on-board battery 13 but also is supplied to other loads and/or a power supply unit such as the driving motor 14 and the discharge reactor 36 (see FIG. 5).

The on-board combustor 11A functions as a heater of a vehicle, heating the intake air with radiant heat from the combustion chamber 20 at a time when the intake air passes through the cylindrical heat transfer passage 28. The heated air is used to heat the vehicle compartment, and the clean heated air, containing no hazardous components such as the combustion gas, is used to heat the vehicle compartment, thereby achieving the comfortable and desirable heating.

The on-board combustor 11A consumes fuel as small as several % to an over-ten % of the fuel consumed by the engine, so that the fuel cost of gasoline or light oil is substantially reduced. Since the on-board combustor 11A is driven separately from the engine, comfortable heating can be continuously provided by the on-board combustor 11A operating even at a time of the engine operation stop.

At that time, since the on-board combustor 11A having a small-volume combustion chamber 20 consumes less fuel, operating noise of the on-board combustor 11A is not distracting in practice and the comfortable heating can be provided.

The on-board combustor 11A remains operable with the engine stopping, and the power generated by the generator 12 mounted to the on-board combustor 11A can be used to operate the driving motor 14 and the discharge reactor 36 of the exhaust gas cleanup system 35 and also to operate the on-board combusting generation system 10. This arrangement eliminates the need for using power of the on-board battery 13 for operating the on-board combusting generation system 10.

During the engine stop, the battery 13 is not relied on as a power for controlling the on-board combusting generation system 10 and as a power for driving the motors, so that the on-board combusting generation system 10 can be left continuously running for heating the vehicle compartment for a long period of time. Furthermore, since the heating of the interior of the vehicle (vehicle heating) does not require the running of the engine, comfortable heating can be given even at the idle stop state. In comparison with the case in which heating is provided at the time of the engine idling operation, the fuel consumption can be significantly reduced and the emission of CO₂ can be also substantially reduced. Moreover, an environmentally friendly on-board combustor 11A can thus be provided.

FIG. 8 is a block diagram illustrating the principle of an on-board generation system 10B according to the third embodiment of the present invention.

The on-board combusting generation system 10B of the third embodiment uses a cylindrical heat radiation passage formed for the low-temperature system line 22 as a water supply passage. A water supply pump 40, driven by the driving motor 14, supplies unheated water to the water supply passage. The unheated water is heated when passing through the water supply passage, and the resulting heated water is used to heat the vehicle compartment and the inner space of the vehicle.

In the on-board combusting generation system 10B, the driving motor 14 drives the fan 15 and the fuel pump 16 in addition to the water supply pump 40. With the fan 15 operating, the air is supplied to the combustion chamber 20 of an on-board combustor 11B. The combustion chamber 20 is also supplied with a fuel such as gasoline or light oil by the operation of the fuel pump 16, and the supplied fuel and air are mixed and combusted in the combustion chamber 20.

The thermal energy in the form of the combustion gas as a thermal medium generated in the combustion process in the combustion chamber 20 acts on one end of the generator 12, and in accordance with the temperature difference between this one end and the supplied water acting on the other end of the generator 12, the thermal energy is converted by the generator 12 in accordance with such temperature difference into the electric energy, thereby generating electric power. The generated power is utilized for charging the battery 13 and for operating the driving motor 14 and the exhaust gas cleanup system 35.

In comparison with the on-board combusting generation system 10 of the first embodiment, the on-board combusting generation system 10B includes the generator 12 in which supply water (unheated water) is utilized in place of intake air and warm (heated) water is utilized as warm air to thereby recover the electric power. A cooling water of a radiator, not shown, or circulating water of a vehicle heating system may be used for the unheated water and heated water used in the on-board combusting generation system 10B of this third embodiment. The other structures of the on-board combusting generation system 10B are substantially the same as or identical to those of the on-board combusting generation system 10, so that the corresponding elements or parts are designated with like reference numerals and the explanations thereof are omitted herein.

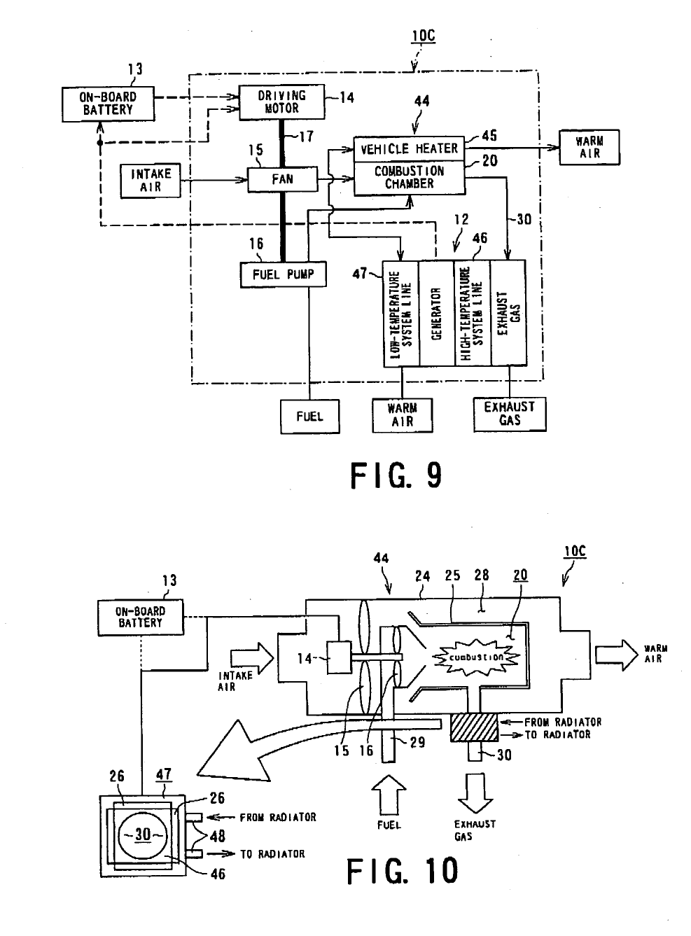

FIGS. 9 and 10 are block diagrams illustrating the principle of an on-board generation system 10C of the fourth embodiment of the present invention.

The difference between the on-board combusting generation system 10C and the on-board combusting generation system 10 of the first embodiment resides in that the generator 12 is separated from a vehicle (on-board) heater 44 and is arranged to the gas discharge passage 30 extending from the vehicle heater 44. The other structures of the on-board combusting generation system 10C are substantially the same as or identical to those of the on-board combusting generation system 10, so that the corresponding elements or parts are designated with like reference numerals and the explanations thereof are omitted herein.

FIG. 10 illustrates the structure of the vehicle heater 44. The vehicle heater 44 is identical to that for the on-board combustor 11 shown in FIG. 2 with the generator 12 being removed. The other structures of the vehicle heater 44 are substantially identical to those of the on-board combustor 11 shown in FIG. 2, and like elements are designated like reference numerals and the discussion thereof is omitted herein. The vehicle heater 44 heats the intake air by the combustion chamber 20 and through combustion process carried out therein. The combustor casing 25 functions as a heat exchanger 45 that heats the intake air. The heat radiated from the combustor casing 25 heats the intake air passing through the cylindrical heat transfer passage 28 to thereby produce the warm air, which is then used for heating the vehicle compartment and the inner space of the vehicle.

The generator 12 is mounted to the heater 44 from the outside thereof. The generator 12 includes a heat exchanger or a heater 46 arranged around the gas discharging passage 30, and the generation modules 26 are also arranged on the outside of the heat exchanger or the heater 46. A heat discharging passage 47 is arranged on the outer peripheral side of the generation modules 26.

The exhaust gas passing through the gas discharging passage 30 functions as the thermal medium. The exhaust gas and the heat exchanger or the heater 46 constitute a high-temperature system line, and on the other hand, the heat discharging passage 47 constitutes the low-temperature system line. When the fan 15 is operated, the air is taken through piping or ducts 48. Air, heated by the heat discharging passage 47, is mixed with warm air from the heat exchanger 45, and the mixed air may be provided for heating the vehicle compartment or may be directly discharged out of the vehicle. The heat discharging passage 47 constitutes a cool water passage, which may be connected to a radiator, not shown, through the piping 48 to circulate cooling water between it and the radiator.

The generator 12 composed by assembling the generation modules 26 generates the power in accordance with the temperature difference between thermal energy of the exhaust gas passing through the gas discharging passage 30 and the intake air or cooling water circulating through the heat discharging passage 47. The power given by the generator 12 is fed to the battery 13 and other loads such as the driving motor 14 and a power supply unit for controlling.

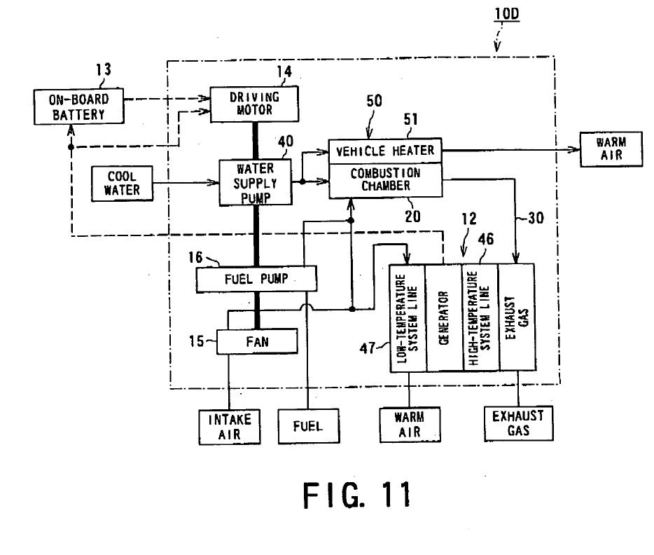

FIG. 11 is a block diagram illustrating the principle of an on-board combusting generation system 10D according to the fifth embodiment of the present invention.

The on-board combusting generation system 10D of the fifth embodiment includes a vehicle (on-board) heater 50 disposed independently from the generator 12. The vehicle heater 50 includes a combustion chamber 20 for combusting a mixture of the intake air and the fuel, and a heat exchanger 51 for heating the supplied (unheated water) water. The water heated by the heat exchanger 51 is supplied for heating the vehicle compartment.

The generator 12 is substantially identical in structure to the generator shown in FIG. 9. Like elements are designated with like reference numerals, and the explanation thereof is omitted herein.

In the on-board combusting generation system 10D, the vehicle heater 50 and the generator 12 are arranged independently from the engine. The vehicle compartment is heated by the water heated by the vehicle heater 50 or by the warm air discharged through the heat discharging passage 47 of the generator 12.

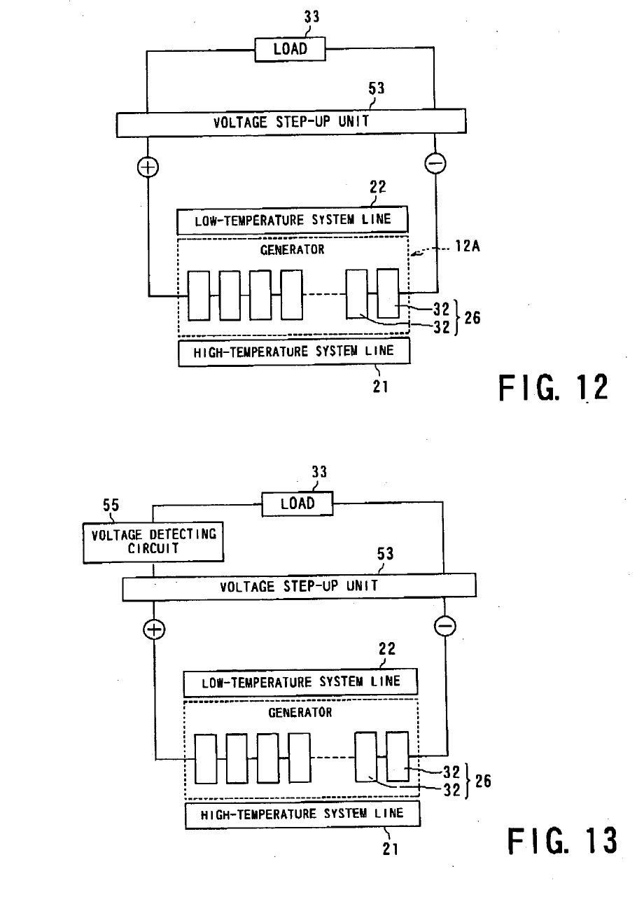

FIG. 12 illustrates a first modification of the generator in the on-board generation system of the embodiments of the present invention.

The generator 12A as the first modification includes a voltage step-up unit 53 in the generator 12 shown in FIG. 3. The voltage step-up unit 53 is arranged between the generator 12A and the load 33 so as to adjust the voltage of the generator 12A to the load 33.

Instead of the voltage step-up unit 53, a voltage step-down unit may be used. Further, these voltage step-up unit 53 and the voltage step-down unit may be both disposed. The voltage step-down unit also acts to adjust the voltage of the generator 12A to the load 33. The structures other than the above of this modification are substantially the same as or identical to those of the generator 12 of FIG. 3. The like elements are designated with like reference numerals and the explanation thereof is omitted herein.

FIG. 13 illustrates a second modification 12B of the generator in the on-board generation system of the embodiments of the present invention.

The generator 12B as the second modification includes, in addition to the voltage step-up unit 53 or the voltage step-down unit connected to the load 33, a voltage detecting circuit 55 that automatically detects and discriminates the voltage of the generator 12B. The voltage detecting circuit 55 also functions as a switch circuit for performing a power system control including ON-OFF control of the electric circuit. Another power control circuit may be also arranged on the installation location of the voltage detecting circuit 55.

According to the present invention, the advantageous effects and/or functions described before can be effectively achieved or realized.

It is also to be noted that the present invention is not limited to the described embodiments and many other changes and modifications may be made without departing from the scopes of the appended claims.

What is claimed is:

1. An on-board generation system comprising:
an on-board combustor mounted to a vehicle independently from an engine thereof; and
an electric generator, mounted to the on-board combustor, for recovering a thermal energy obtained through combustion process as an electric energy by using a thermoelectric converter,
wherein the electric power generated by the electric generator is supplied even at a time of engine operation stop.

2. An on-board generation system according to claim 1, further comprising an exhaust gas cleanup device arranged in an exhaust gas line extending from the on-board combustor, said exhaust gas cleanup device including a discharge reactor for generating chemically active species by carrying out a discharging process to the exhaust gas and a catalyst reactor having a catalyst activated by the chemically active species generated in the discharge reactor.

3. An on-board generation system according to claim 1, wherein the electric generator comprises one of a thermoelectric converter, a thermionic energy converter, and a combination thereof.

4. An on-board generation system according to claim 3, wherein one of the thermoelectric converter, a thermionic energy converter and the combination thereof constitutes a generation module.

5. An on-board generation system according to claim 4, wherein the combustor has a cylindrical combustor casing and at least one of the generation modules is mounted to an outer peripheral surface of the combustor casing.

6. An on-board generation system according to claim 4, wherein the combustor has a cylindrical combustor casing and at least one of the generation modules is mounted to an inner peripheral surface of the combustor casing.

7. An on-board generation system according to claim 1, wherein the electric generator comprises either one of a voltage step-up unit and a voltage step-down unit for adjusting the generated power to a load during use.

8. An on-board generation system according to claim 1, wherein the electric generator comprises a voltage detecting circuit for automatically detecting and discriminating the generation of voltage, said voltage detecting circuit controlling a power supply by making or breaking an electric line supplying power from the electric generator to a load.

9. An on-board generation system comprising:
an on-board combustor mounted to a vehicle independently from an engine thereof;
a high-temperature system line for circulating a thermal medium for receiving heat caused through a combustion process in the combustor;
a low-temperature system line for circulating a medium on a low-temperature side which is subjected to heat exchanging with the thermal medium; and
an electric generator, arranged between the high-temperature system line and the low-temperature system line, for recovering the thermal energy of the thermal medium as electric energy,
wherein the electric power generated by the electric generator is supplied to a power source including either one of an on-board battery and a power supply element for driving a vehicle equipment.

10. An on-board generation system according to claim 9, wherein the thermal medium on the high-temperature system line is either one of a combustion gas in a combustion chamber of the on-board combustor and an exhaust gas discharged from the combustion chamber, and the low-temperature side medium is either one of an air outside a vehicle and an air inside the vehicle.

11. An on-board generation system according to claim 9, wherein the thermal medium on the high-temperature system line is either one of a combustion gas in a combustion chamber of the on-board combustor and an exhaust gas discharged from the combustion chamber, and the low-temperature side medium is a water circulated from either one of a radiator and an on-board heating system.

12. An on-board generation system according to claim 9, wherein the thermal medium on the high-temperature system line is an exhaust gas subsequent to the combustion process in a combustion chamber of the combustor, and the low-temperature side medium is a water circulated from either one of a radiator and an on-board heating system.

13. An on-board generation system according to claim 9, further comprising an exhaust gas cleanup device arranged in an exhaust gas line extending from the on-board combustor, said exhaust gas cleanup device including a discharge reactor for generating chemically active species by carrying out a discharging process to the exhaust gas and a catalyst reactor having a catalyst activated by the chemically active species generated in the discharge reactor.

14. An on-board generation system according to claim 13, wherein the electric generator supplies power to at least one of the exhaust gas cleanup device and the power source including either one of the on-board battery and the power supply element for driving a vehicle equipment.

15. An on-board generation system according to claim 9, wherein the electric generator comprises one of a thermoelectric converter, a thermionic energy converter, and a combination thereof.

16. An on-board generation system according to claim 15, wherein one of the thermoelectric converter, a thermionic energy converter and the combination thereof constitutes a generation module.

17. An on-board generation system according to claim 16, wherein the combustor has a cylindrical combustor casing and at least one of the generation modules is mounted to an outer peripheral surface of the combustor casing.

18. An on-board generation system according to claim 16, wherein the combustor has a cylindrical combustor casing and at least one of the generation modules is mounted to an inner peripheral surface of the combustor casing.

19. An on-board generation system according to claim 9, wherein the electric generator comprises either one of a voltage step-up unit and a voltage step-down unit for adjusting the generated power to a load during use.

20. An on-board generation system according to claim 9, wherein the electric generator comprises a voltage detecting circuit for automatically detecting and discriminating the generation of voltage, said voltage detecting circuit controlling a power supply by making or breaking an electric line supplying power from the electric generator to a load.
